(19) United States
(12) Patent Application Publication
(10) Pub. No.: US 2015/0042745 A1
(43) Pub. Date: Feb. 12, 2015

(54) FILE OPERATION METHOD AND FILE OPERATION APPARATUS FOR USE IN NETWORK VIDEO CONFERENCE SYSTEM

(71) Applicants: PEKING UNIVERSITY FOUNDER GROUP CO., LTD., BEIJING (CN); BEIJING FOUNDER ELECTRONICS CO., LTD., BEIJING (CN); FOUNDER INFORMATION INDUSTRY GROUP, BEIJING (CN)

(72) Inventor: Yu TIAN, Beijing (CN)

(73) Assignees: PEKING UNIVERSITY FOUNDER GROUP CO., LTD., BEIJING (CN); BEIJING FOUNDER ELECTRONICS CO., LTD., BEIJING (CN); FOUNDER INFORMATION INDUSTRY GROUP, BEIJING (CN)

(21) Appl. No.: 14/084,923

(22) Filed: Nov. 20, 2013

(30) Foreign Application Priority Data
Aug. 6, 2013 (CN) 201310339668.4

(51) Int. Cl. H04N 7/15

(52) U.S. Cl. CPC H04N 7/15
USPC 348/14.03

(57) ABSTRACT

Embodiments of the present invention provide a file operation method and a file operation apparatus for use in a network video conference system. The method comprises: acquiring a user image in real time; identifying a user's limb; judging whether or not the user's limb is associated with a file; and if the user's limb is associated with the file, matching a limb action of the user with a predetermined action set, so as to operate the file. When using the network video conference system, users can operate the file on a desktop through the limb actions, so as to facilitate the communication between the users and improve the user experience.

### CROSS-REFERENCE TO RELATED APPLICATIONS

The present application claims priority to Chinese Patent Application No. 201310339668.4 filed before the Chinese Patent Office on Aug. 6, 2013 and entitled “File Operation Method and File Operation Apparatus for Use in Network Video Conference System”, which is incorporated herein by reference in its entirety.

### TECHNICAL FIELD

The present invention relates to the field of communication, in particular to a file operation method and a file operation apparatus for use in a network video conference system.

### BACKGROUND

Recently, along with the rapid development of the network, for users in different places, an identical desktop may be displayed in two places via a shared desktop, so that a local user and a remote user can work under the same desktop.

However, in the prior art, usually operations on files such as pictures and documents cannot be performed cooperatively, i.e., the files will be operated by one side and viewed by the other. In addition, files and information need to be transmitted and expressed by virtue of physical devices such as a mouse or a keyboard, which results in unsmooth communication and poor user experience.

### SUMMARY

An object of the present invention is to provide a file operation method and a file operation apparatus for use in a network video conference system.

One aspect of the present invention provides a file operation method for use in a network video conference system, comprising:
acquiring a user image in real time;
identifying a user's limb;
judging whether or not the user's limb is associated with a file; and
if the user's limb is associated with the file, matching a limb action of the user with a predetermined action set, so as to operate the file.

Another aspect of the present invention provides a file operation apparatus for use in a network video conference system, comprising:
an image acquisition unit configured to acquire a user image in real time;
a limb identification unit configured to identify a user's limb; and
a limb action processing unit configured to judge whether or not the user's limb is associated with a file, and if the user's limb is associated with the file, match a limb action of the user with a predetermined action set so as to operate the file.

According to the embodiments of the present invention, when using the network video conference system, the user can operate the file on a desktop through the limb actions, so as to facilitate the communication between the users and improve the user experience.

### BRIEF DESCRIPTION OF THE DRAWINGS

FIG. 1 is a flow chart of a file operation method 1000 for use in a network video conference system according to one embodiment of the present invention; and

FIG. 2 is a diagram showing a file operation apparatus 100 for use in a network video conference system according to one embodiment of the present invention.

### DETAILED DESCRIPTION

Embodiments of the present invention will be described hereinafter in conjunction with the drawings.

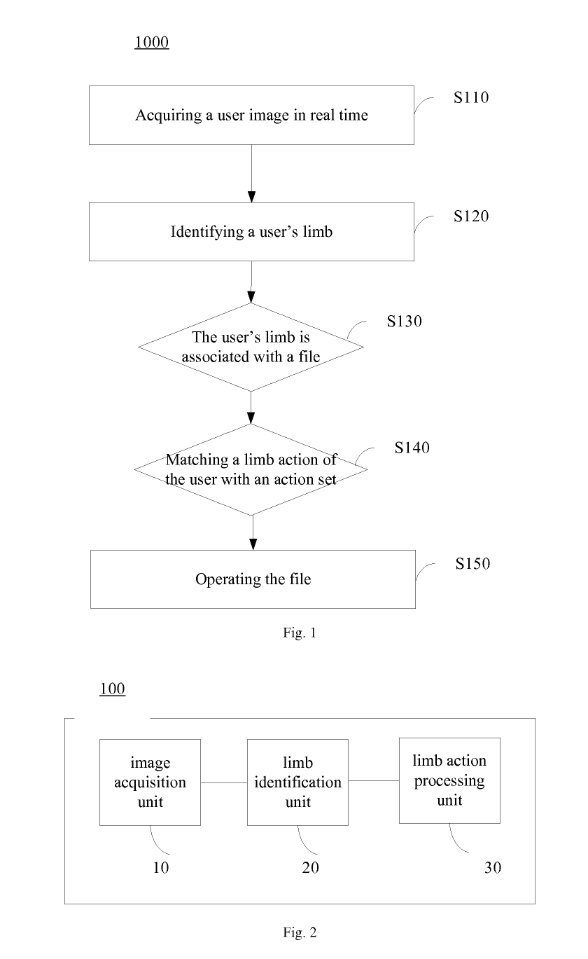

FIG. 1 is a flow chart of a file operation method 1000 for use in a network video conference system according to one embodiment of the present invention. As shown in FIG. 1, the method comprises a step S110 of acquiring a user image in real time, a step S120 of identifying a user's limb, a step S130 of judging whether or not the user's limb is associated with a file, a step S140 of, if the user's limb is associated with the file, matching a limb action of the user with a predetermined action set, and a step S150 of operating the file according to the matched limb action.

In step S110, the user image may be acquired via a camera. In step S120, the acquired user image may be converted from a RGB color space into an HSV color space, and then a skin color detection may be executed to identify the user's limb. For example, an image within a threshold range may be identified as the user's limb, and an image and a 2D coordinate of the identified limb may be stored in an array. For instance, the threshold range may be set as 0<H<20, 51<S<255, 0<V<255. The image and the 2D coordinate of the identified limb are extracted from the array, user's head and hands are identified according to convex hulls, and then convex hull process is performed on images of the user's hands so as to identify a hand action of the user. For example, the user's hand action may include the action of a single finger, a palm and a fist. In addition, a center of gravity of the head may be calculated so as to distinguish between left and right hands.

For example, when the user is desired to perform a selection operation on a picture through his fist, a user image is acquired at first through a camera, and the user's head and hands are identified. Then, it is to judge whether there is an intersection between a 2D coordinate of the user's hands and a 2D coordinate of the picture. If yes, it is to judge whether or not the user's hand action matches a “selection” action in the action set. For example, in the action set, the hand action being a fist indicates the “selection” action, and when it is judged that the user's hand action is a fist, the picture will be selected by the user through the hand action. After the user selects the picture, when the user moves his hand, the picture will move too. When the user moves beyond an effective range of the camera, the picture will disappear, and when the user enters again the effective range, the picture will still be attached to the user's hand. When a user's gesture is changed from fist to palm, the selection of the picture will be cancelled, and the picture is fixed at a position of a screen where the user's hand is located when the selection is cancelled.

When the local and remote users place their fists on the picture simultaneously, the picture will be selected and then operated cooperatively by the users. The cooperative operations that may be performed by both the local and remote users include zooming in, zooming out and rotating, and these operations may be performed in real time. The picture may be zoomed in and out along with a change of the distance between the local user's hand and the remote user's hand. When the distance increases, the picture will be zoomed in, and when the distance decreases, the picture will be zoomed out. In addition, the picture may be rotated along with a change of an angle between the two hands and the X axis. When the gesture of any one of the users is changed from fist to palm, the cooperative operation will be ended.

For another example, when a user places a single finger on the picture, the picture will be selected and then annotated (doodled). Along with the movement of the user's finger, annotations will be left in the picture. When the gesture of the user is changed from single finger to palm, the selection will be cancelled and the annotations will be stored in the picture.

FIG. 2 is a diagram showing a file operation apparatus 100 for use in a network video conference system according to one embodiment of the present invention. As shown in FIG. 2, the apparatus 100 comprises an image acquisition unit 10 configured to acquire a user image in real time, a limb identification unit 20 configured to identify a user's limb, and a limb action processing unit 30 configured to judge whether or not the user's limb is associated with a file, and if yes, match a limb action of the user with a predetermined action set so as to operate the file.

For example, the image acquisition unit 10 may be a camera for acquiring the user image. The limb identification unit 20 may convert the user image from a RGB color space into an HSV color space, and perform a skin color detection to identify the user's limb. For examiner, the limb identification unit 20 will identify an image within a threshold range as the user's limb and store an image and a 2D coordinate of the identified limb in an array. For instance, the threshold range may be set as 0<H<20, 51<S<255, 0<V<255. The limb identification unit 20 is further configured to extract the image and the 2D coordinate of the identified limb from the array, identify user's head and hands, and perform convex hull processing on images of the user's hands so as to identify a hand action of the user. The user's hand action may include the action of a single finger, a palm and a fist. In addition, the limb identification unit 20 may be further configured to calculate a center of gravity of the head so as to distinguish between left and right hands.

For example, when the user is desired to perform a selection operation on a picture through his fist, at first the image acquisition unit 10 (e.g., the camera) acquires the user image and the limb identification unit 20 identifies the user's head and hands. Then, the limb action processing unit 30 judges whether there is an intersection between a 2D coordinate of the user's hands and a 2D coordinate of the picture, and if yes, judges whether or not the user's hand action matches a “selection” action in the action set. For example, in the action set, the hand action being a fist indicates the “selection” action, and when it is judged that the user's hand action is a fist, the picture will be selected by the user through the hand action.

The above are merely the preferred embodiments of the present application, and these embodiments are not used to limit the protection scope of the present application. It should be noted that, a person skilled in the art may further make improvements and modifications without departing from the principle of the present invention, and these improvements and modifications shall also be considered as the scope of the present invention.

1. A file operation method for use in a network video conference system, comprising:
acquiring a user image in real time;
identifying a user's limb;
judging whether or not the user's limb is associated with a file; and
if the user's limb is associated with the file, matching a limb action of the user with a predetermined action set, so as to operate the file.

2. The method according to claim 1, wherein the step of identifying a user's limb comprises:
converting the acquired user image from a RGB color space into an HSV color space; and
performing a skin color detection so as to identify the user's limb.

3. The method according to claim 1, wherein the step of performing a skin color detection so as to identify the user's limb comprises:
identifying an image within a threshold range as the user's limb and storing an image and a 2D coordinate of the identified limb;
identifying the user's head and hands according to convex hulls; and
performing convex hull process on images of the user's hands so as to identify a hand action of the user.

4. The method according to claim 3, wherein subsequent to identifying the user's head and hands according to convex hulls, the method further comprises:
calculating a center of gravity of the head so as to distinguish between left and right hands.

5. The file operation method according to claim 3, wherein the step of judging whether or not the user's limb is associated with a file comprises:
judging whether there is an intersection between a 2D coordinate of any one of the user's hands and a 2D coordinate of the file.

6. The file operation method according to claim 4, wherein the step of judging whether or not the user's limb is associated with a file comprises:
judging whether there is an intersection between a 2D coordinate of any one of the user's hands and a 2D coordinate of the file.

7. A file operation apparatus for use in a network video conference system, comprising:
an image acquisition unit configured to acquire a user image in real time;
a limb identification unit configured to identify a user's limb; and
a limb action processing unit configured to judge whether or not the user's limb is associated with a file, and if the user's limb is associated with the file, match a limb action of the user with a predetermined action set so as to operate the file.

8. The apparatus according to claim 7, wherein the limb identification unit is further configured to convert the acquired user image from a RGB color space into an HSV color space, and perform a skin color detection so as to identify the user's limb.

9. The file operation apparatus according to claim 7, wherein the limb identification unit is further configured to identify an image within a threshold range as the user's limb and store an image and a 2D coordinate of the identified limb, identify the user's head and hands according to convex hulls, and perform convex hull process on images of the user's hands so as to identify a hand action of the user.

10. The file operation apparatus according to claim 9, wherein the limb identification unit is further configured to calculate a center of gravity of the head so as to distinguish between left and right hands.

11. The file operation apparatus according to claim 9, wherein the limb action processing unit is further configured to judge whether there is an intersection between a 2D coordinate of any one of the user's hands and a 2D coordinate of the file.

12. The file operation apparatus according to claim 10, wherein the limb action processing unit is further configured to judge whether there is an intersection between a 2D coordinate of any one of the user's hands and a 2D coordinate of the file.
